(19) United States
(12) Patent Application Publication
(10) Pub. No.: US 2006/0255067 A1
(43) Pub. Date: Nov. 16, 2006

(54) Extension means

(76) Inventor: Louis Di Guiseppe, New Haven, CT (US)

Correspondence Address: LUCAS & MERCANTI, LLP, 475 PARK AVENUE SOUTH, 15TH FLOOR, NEW YORK, NY, 10016, US

(21) Appl. No.: 11/129,127

(22) Filed: May 13, 2005

(51) Int. Cl. B67D 5/64

(52) U.S. Cl. 222/174

(57) ABSTRACT

An extension means for aerosol spraying into hard to reach places comprising an extension pole with a bottom bracket to secure the base of the aerosol container, an upper bracket to secure the upper portion of the aerosol container, a hinge secured to the upper end of the pole provided with a dowel adapted to make contact with the spray nozzle of the aerosol container and activating means to pull the hinge so the dowel will contact the spray nozzle.

An extension means for aerosol spraying in hard-to-reach places or at a safe distance.

### STATE OF THE ART

Insect nests such as bee nests or other stinging insects are often in hard to reach places such as upper reaches of a house or under the house eaves or the sprayer wishes to be a safe distance for when the insects are attacked by the spray.

### OBJECTS OF THE INVENTION

It is an object of the invention to provide an extension means useful for insect spraying.

It is another object of the invention to provide a method of attacking insects safely.

These and other objects and advantages of the invention will become obvious from the following detailed description.

### THE INVENTION

The extension means of the invention for aerosol spraying into hard to reach places comprises an extension pole with a bottom bracket to secure the base of the aerosol container, an upper bracket to secure the upper portion of the aerosol container, a hinge secured to the upper end of the pole provided with a dowel adapted to make contact with the spray nozzle of the aerosol container and activating means to pull the hinge so the dowel will contact the spray nozzle.

The extension may be made of any suitable material such as wood or a hollow metal pole made of iron, aluminum or any suitable metal and is of a suitable length that can be easily controlled such as about 6 feet long. The lower end may be provided with an extension nipple to engage a second pole to extend the reach thereof.

The activating means for moving the hinge to have the dowel make contact with the spray nozzle may be a string or cord or other suitable engagement means so the operator can pull the hinge downward.

### BRIEF DESCRIPTION OF THE DRAWINGS

FIG. 1 is a plan view of one embodiment of the invention.

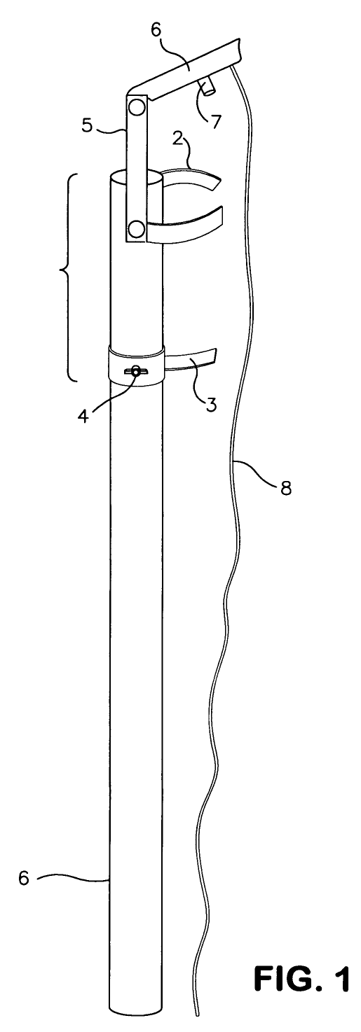

The extension means of the invention is comprised of an elongated pole 6 provided at the upper end thereof with an upper bracket 2 and a lower bracket 3. The lower bracket is adapted to secure the bottom of the aerosol container in place and is adjustable by a wing nut 4 to adjust for different size containers. The lower bracket is usually approximately 8½ inches from the upper end of the pole to accommodate the normal aerosol container.

The upper bracket 2 is approximately several inches from the upper end and is secured to the pole by screws or other appropriate means. Near the upper bracket 2, there is a rod 5 secured to the pole with a hinged extension 6 provided with an adjustable dowel 7 to engage the spray nozzle on the aerosol container. Attached to the far end of extension 6 is an activating means 8 such as a string or cord to pull the extension 6 downward until the dowel 7 contacts the spray nozzle to spray the contents of the aerosol container.

The pole can be provided with means at its lower end to engage a second pole to extend the reach of the extension means. The second pole may be hollow to encompass the end of the first pole which may be provided with an extension nipple to cooperate with a hole in the second pole to secure the attachment of the two poles.

The method of spraying to combat insects, for instance, comprises mounting an aerosol container in the brackets of the extension means, positioning the aerosol container in the desired position and then activating the spray nozzle of the aerosol container by contacting the same with the dowel in a downward direction to spray the contents thereof.

Various modifications of the extension means and the method may be made without departing from the spirit or scope thereof and it is to be understood that the invention is intended to be limited only as defined in the appended claims.

What I claim is:

1. An extension means for aerosol spraying into hard to reach places comprising an extension pole with a bottom bracket to secure the base of the aerosol container, an upper bracket to secure the upper portion of the aerosol container, a hinge secured to the upper end of the pole provided with a dowel adapted to make contact with the spray nozzle of the aerosol container and activating means to pull the hinge so the dowel will contact the spray nozzle.

2. The extension means of claim 1 provided at the bottom end with an extension nipple to engage a second pole for additional extension.

3. The extension means of claim 1 wherein the pole is hollow metal.

4. The extension means of claim 1 wherein the pole is made of wood.

5. The extension means of claim 1 where the activating means is a string or cord attached to the end of the hinge.

6. The extension means of claim 1 wherein the lower bracket is provided with a wing nut for adjustment of the bracket to accommodate different size aerosol containers.

7. The extension means of claim 1 wherein the dowel is adjustable to adjust to different spray nozzles.

8. A method of killing insects comprising mounting an insect repellent aerosol container in the extension means of claim 1, positioning the aerosol container near the insect nest and activating the aerosol nozzle by pulling the means to have the dowel engage the spray nozzle.

9. The method of claim 6 wherein the activating means is a string or cord attached to the end of the hinge.
